(19) United States
(12) Patent Application Publication
(10) Pub. No.: US 2003/0016995 A1
(43) Pub. Date: Jan. 23, 2003

(54) Fastening structure for tubular apparatus

(76) Inventor: Lausan Chung-Hsin Liu, Hsin-Tien City (TW)

Correspondence Address: BACON & THOMAS, PLLC, 625 SLATERS LANE, FOURTH FLOOR, ALEXANDRIA, VA, 22314

(21) Appl. No.: 09/908,778

(22) Filed: Jul. 20, 2001

(51) Int. Cl. F16B 1/00; F16D 1/00; B25G 3/08

(52) U.S. Cl. 403/381

(57) ABSTRACT

A fastening structure for tubular apparatus includes a transfer tube element fixedly fastened to the top end of a first tube member having one end formed a first collar section by extrusion, and a second tube member having one end tapered to form a first neck section matching the first collar section. The second tube member further extends from the first neck section to form a free end coupling section with an anchor plug fixedly engaging therein. The transfer tube element is fastened to a sealing element through engaging a fastener with the anchor plug thereby to form a secured and sightly fastening among the first and second tube member and the transfer tube element.

### BACKGROUND OF THE INVENTION

The present invention relates to a fastening structure for tubular apparatus and particularly a structure that employs a transfer tube element to fasten a first tube member and a second tube member to form a secured and sightly fastening.

Tubular side frames are widely used in conventional furniture. There are generally made in the following two types: one is to bend a tube to form an integral rectangular frame that has straight lines or a curvy profile with the side frame extending downwards to become the rear legs of a chair as shown in FIG. 1. The side frames thus made usually have sharp angles at the bent sections and tend to injure people when using inadvertently. The products formed by bending method also have styling limitation and do not have much appealing.

Another type of side frame is bridging a transverse rod between two upright rear legs at the top ends and soldering or screwing the transverse rod to the rear legs. The junctures have soldering points or screw bores and elements. They usually spoil the appearance of the chairs.

### SUMMARY OF THE INVENTION

The primary object of the present invention is to resolve the foregoing disadvantages. The invention provides a transfer tube element fixedly fastening to the top end of a first tube member. The transfer tube element has a first collar section formed at one end by extrusion. There is a second tube member which has one end tapering to form a first neck section to match the first collar section. The first neck section extends to form a coupling section at the free end of the second tube member. The coupling section has an anchor plug fixedly located therein. Another end of the transfer tube element engages with a sealing element which is fastened to the anchor plug through a fastener. Thereby the first and second tube member and transfer tube element form a sturdy and sightly fastening structure.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional fastening structure.

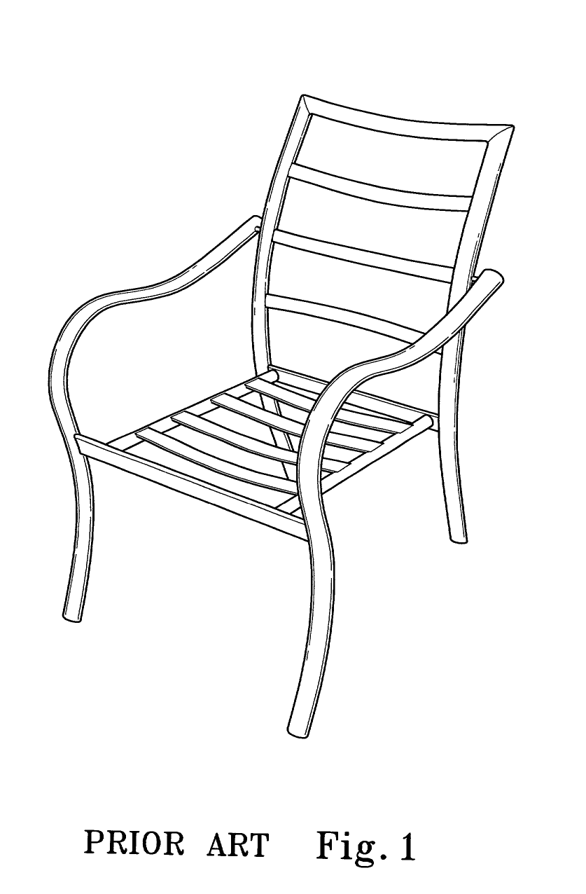

FIG. 2 is a perspective view of the invention.

FIG. 3 is an exploded view of the invention.

FIG. 4 is a sectional view of the invention.

FIG. 5 is an exploded view of another embodiment of the invention.

### DESCRIPTION OF THE PREFERRED EMBODIMENTS

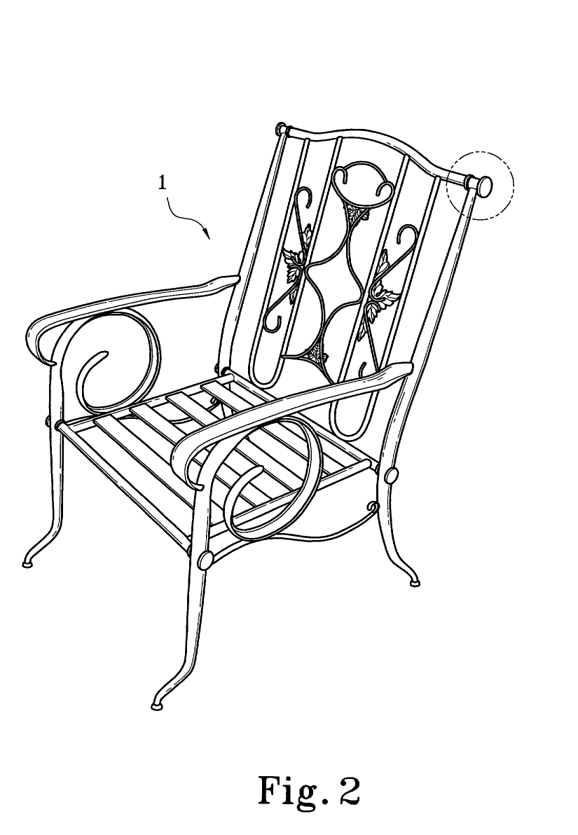

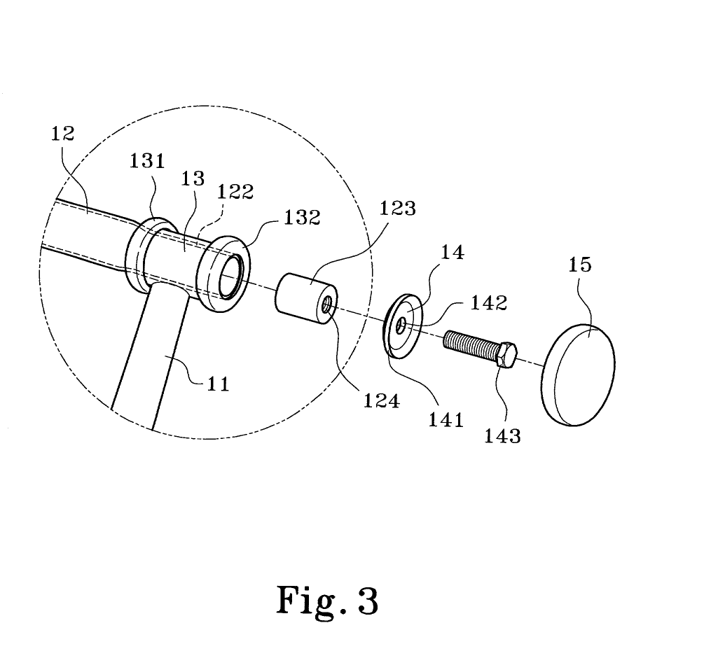

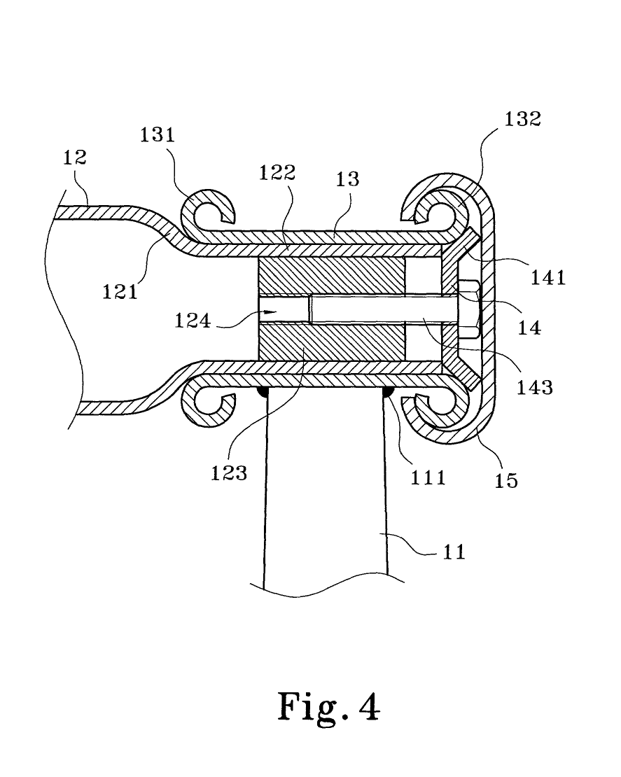

Referring to FIGS. 2, 3 and 4, a chair 1 with rear legs (first tube member 11) fastening to a second tube member 12 located on the upper end of the back frame has been used as an embodiment of the invention for the following descriptions. The fastening structure of the invention includes a first tube member 11 which has the top end soldered to a transfer tube element 13 at the peripheral surface in the middle section with soldering points 111 to form a fixed engagement. The transfer tube element 13 has one end formed a first collar section 131 by extrusion. One end of the second tube member 12 is tapered to form a first neck section 121 matching the first collar section 131, and extends further to form a coupling section 122 insertable into the free end of the transfer tube element 13. There is an anchor plug 123 wedging into the coupling section 122 and fixedly engaging with the inner wall thereof The anchor plug 123 has a screw bore 124 formed therein and eventually functions as a packing element. The transfer tube element 13 has another end formed a second collar section 132 to couple with a sealing element 14. The sealing element 14 has a tapered annular second neck section 141 matching the second collar section 132 and an aperture 142. The sealing element 14 may be fastened to the anchor plug 123 by a fastener 143 through the aperture 142 thereby to make the second collar section 132 pressing against the second neck section 141. Thus complete the fastening of the first tube member 11 and second tube member 12 and the transfer tube element 13.

As shown in the drawings, when the second tube member 12 is inserted into the transfer tube element 13, the first neck section 121 will be stopped and harnessed by the first collar section 131, thus making the second tube member 12 wedged in the transfer tube element 13 without moving forwards. Then use the fastener 143 to pass through the aperture 142 to engage with the anchor plug 123 thereby to form a forced contact and harness between the second collar section 132 and the second neck section 141 of the sealing element 14 so the second tube member 12 will form a secured fastening to the transfer tube element 13 without moving away. The first and second collar section 131 and 132 may be extruded to form curvy profiles. The outer end of the second collar section 132 may further be covered by an ornamental cap 15 to give the structure more appealing look. The curvy profiles also may prevent people from injury when hitting the structure inadvertently.

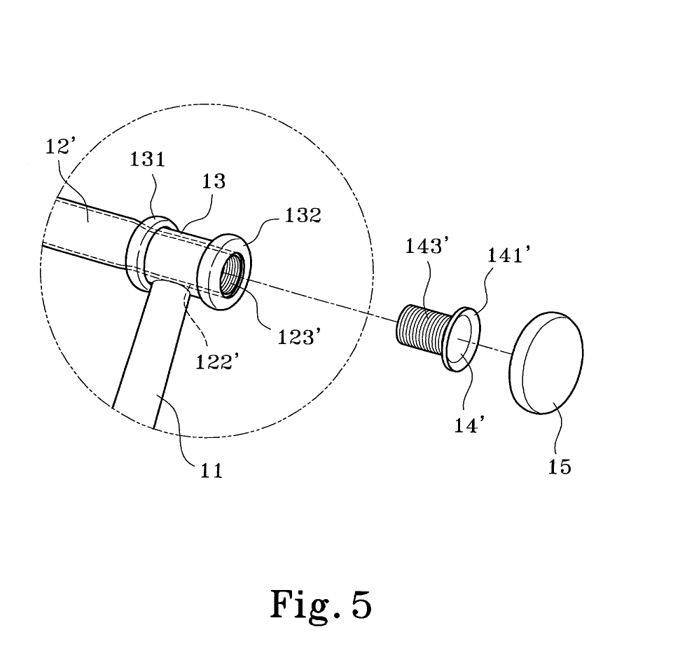

Referring to FIG. 5 for another embodiment of the invention, the coupling section 122′ has internal screw threads formed on the inner wall to serve the function of the anchor plug 123′. The fastener 143′ is integrally formed with the sealing element 14′ with external screw threads. Hence the sealing element 14′ may directly screw to the inner wall of the coupling section 122′ to allow the first and second collar section 131 and 132 forming constraint engagement with the first and second neck section 121′ and 141′ thereby to accomplish secured fastening of the first and second tube member 11 and 12′ and the transfer tube element 13.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

What is claimed is:

1. A fastening structure for tubular apparatus, comprising:
a transfer tube element fixedly fastened to the top end of a first tube member having one end formed a first collar section by extrusion;
a second tube member having one end formed a coupling section housing in the transfer tube element and a tapered first neck section adjacent to the coupling section and being harnessed by the first collar section;
an anchor plug located in the coupling section and being fixedly engaged with the inner wall of the coupling section; and
a sealing element engaging with the anchor plug through a fastener for fastening the second tube member to the transfer tube element and the first tube member.

2. The fastening structure for tubular apparatus of claim 1, wherein the transfer tube element has another end formed a second collar section by extrusion, the sealing element having a tapered annular second neck section matching the second collar section.

3. The fastening structure for tubular apparatus of claim 1, wherein the first and the second collar section are formed by extrusion with curvy profiles.

4. The fastening structure for tubular apparatus of claim 1, wherein the anchor plug is internal screw threads formed on the inner wall of the coupling section.

5. The fastening structure for tubular apparatus of claim 1, wherein the anchor plug is a packing element engaged with the inner wall of the coupling section having a screw bore formed therein.

6. The fastening structure for tubular apparatus of claim 1, wherein the fastener is integrally formed with the sealing element and has external screw threads formed on the exterior surface of the fastener.

7. The fastening structure for tubular apparatus of claim 1, wherein the first tube member is soldered to the middle section of the peripheral surface of the transfer tube element with soldering points.

8. The fastening structure for tubular apparatus of claim 1, wherein the transfer tube element is coupled with an ornamental cap.
